(19) United States
(12) Patent Application Publication
(10) Pub. No.: US 2016/0209235 A1
(43) Pub. Date: Jul. 21, 2016

(54) APPARATUS, METHOD, AND SYSTEM FOR CALIBRATING ONE OR MORE MOTION SENSORS

(71) Applicants: Jesus T. Fortu, Antelope, CA (US); David A. Rittenhouse, Fair Oaks, CA (US); Gabriel A. Bowers, Jerusalem (IL); Itai Samoelov, Mazor (IL)

(72) Inventors: Jesus T. Fortu, Antelope, CA (US); David A. Rittenhouse, Fair Oaks, CA (US); Gabriel A. Bowers, Jerusalem (IL); Itai Samoelov, Mazor (IL)

(21) Appl. No.: 14/597,629

(22) Filed: Jan. 15, 2015

(51) Int. Cl. G01C 25/00; G01P 21/00

(52) U.S. Cl. CPC G01C 25/00; G01P 21/00

(57) ABSTRACT

Described is an apparatus which comprises: a first sheet, formed of non-metallic material, to position a Device-Under-Test (DUT); and a frame, formed of non-magnetic material, to support the first sheet such that the frame can be oriented in various positions to calibrate one or more sensors associated with the DUT. A method is also provided which comprises: positioning a DUT on a first sheet made from a non-metallic material; securing the position of the DUT using adjustable stoppers coupled to the first sheet, wherein the first sheet is coupled to a frame which is made from a non-magnetic material, and wherein the frame supports the first sheet such that the frame can be oriented in various positions to calibrate one or more sensors associated with the DUT; and orienting the frame in various positions one at a time to calibrate the one or more sensors of the DUT.

### BACKGROUND

Sensor calibration is a method of improving performance of a sensor by mitigating errors in the sensor outputs. Errors in the sensor output are differences between a sensor's expected output and its measured output. Such errors may show up consistently every time a new measurement is taken. These repeatable errors can be calculated during calibration, and are later compensated in real-time when the sensors are being used for their sensing purpose.

Current calibration equipment is expensive, large in size, and not easily portable. For example, current calibration equipment uses high powered motors, magnets, conductive material that can disrupt and impact the accuracy and performance of a sensor. Current calibration equipment also uses robot arms and rate tables to orient the sensors in various positions to calibrate the errors in those positions. These robot arms and rate tables are built using motors and metals which may induce magnetic disturbance to the operation of the sensors. For example, magnetic disturbances may add error to the calibration data associated with calibrating a magnetometer sensor. Current calibration equipment is also expensive (e.g., may cost from $30 k to $75 k). Therefore, it is discouraging to use such equipment for calibration purposes.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1A illustrates a three dimensional (3D) view of a calibration fixture, according to some embodiments of the disclosure.

FIG. 1B illustrates a cross-section of an end of a leg of the calibration fixture, according to some embodiments of the disclosure.

FIG. 1C illustrates a side-view of the leg of FIG. 1B, according to some embodiments of the disclosure.

FIG. 2A illustrates a 3D view of the calibration fixture with a first sheet for positioning a Device-Under-Test (DUT), according to some embodiments of the disclosure.

FIGS. 2B-C illustrate 3D views of part of the calibration fixture having adjustable rectangular stoppers for slots in the first sheet, according to some embodiments of the disclosure.

FIGS. 2D-E illustrates a 3D view of the adjustable rectangular stoppers, according to some embodiments of the disclosure.

FIG. 3 illustrates a 3D view of the calibration fixture with a second sheet for holding the DUT in place on the first sheet, according to some embodiments of the disclosure.

FIG. 4 illustrates a 3D view of the first and second sheets with adjustable stoppers or fasteners, according to some embodiments of the disclosure.

FIG. 5 illustrates a side view of the calibration fixture with the DUT, according to some embodiments of the disclosure.

FIG. 6 illustrates a side view of the calibration fixture in a different orientation with a laptop or tablet as a DUT, according to some embodiments of the disclosure.

FIG. 7 illustrates a top view of the calibration fixture with the first and second sheets, according to some embodiments of the disclosure.

FIG. 8 illustrates a 3D view of the calibration fixture anchored to a reference anchor, according to some embodiments of the disclosure.

FIG. 9 illustrates another 3D view of the calibration fixture anchored to a reference anchor, according to some embodiments of the disclosure.

FIG. 10 illustrates a 3D picture of a calibration fixture with a DUT firmly positioned between the first and second sheets, according to some embodiments of the disclosure.

FIG. 11 illustrates a series of orientations of the calibration fixture to calibrate one or more sensors of the DUT, according to some embodiments of the disclosure.

FIG. 12 illustrates a flowchart of a method for calibrating one or more sensors of the DUT using the calibration fixture, according to some embodiments of the disclosure.

FIG. 13 illustrates a system for processing the calibration data from the calibration fixture having the calibration frame and DUT, according to some embodiments of the disclosure.

FIG. 14 illustrates a smart device, a computer system, a SoC (System-on-Chip), or DUT, according to some embodiments.

FIGS. 15A-C illustrate snapshots of a calibration tool graphical user interface (GUI) used for processing calibration data from DUT, and generating calibration information for one or more sensors of the DUT, according to some embodiments of the disclosure.

### DETAILED DESCRIPTION

Some embodiments describe an apparatus which comprises: a first sheet, formed of non-metallic material, to position a Device-Under-Test (DUT); and a frame, formed of non-magnetic material, to support the first sheet such that the frame can be oriented in various positions to calibrate one or more sensors associated with the DUT. In some embodiments, the first sheet includes adjustable stoppers to position the DUT on the first sheet. Adjustable stoppers may be formed from a variety of materials such as aluminum, plastic, nylon, etc.

In some embodiments, the apparatus comprises a second sheet, formed of non-metallic material, coupled to the DUT such that the DUT is sandwiched between the first and second sheets. In some embodiments, the second sheet includes fasteners to maintain or hold position of the second sheet relative to the DUT. Fasteners may be formed from a variety of materials such as aluminum, plastic, nylon, etc. In some embodiments, the surface area of the first sheet is larger than the surface area of the second sheet.

The apparatus of various embodiments costs a fraction of the price compared to the price of robot arms and rate tables of traditional calibration systems, and with its flexibility and light weight design, the apparatus of various embodiments can be used on phones, tablets, 2-in-1 detachable/convertible portable devices in various screen sizes, etc. without additional attachments or adaptors.

In some embodiments, the materials used for the apparatus are non-conductive and/or non-magnetic. For example, lightweight aluminum frames, polypropylene sheets (hard plastic), aluminum screws, plastic joints, and plastic end caps are used to form various components of the apparatus. By using non-conductive material, the apparatus does not interfere with nor inject noise to the one or more sensors of the DUT (e.g., magnetometer sensor). The light weight design of the apparatus allows flexibility in calibrating various sensor based systems, and allows easy maneuvering to meet the multiple and various XYZ orientations for the calibration software.

The apparatus of various embodiments not only avoids metal and magnetic interferences with sensors (e.g., magnetometer sensor), it also allows for simultaneous calibration of multiple motion sensors such as accelerometers, magnetometers, and gyroscopes regardless of the form factor implementation (e.g., phone, tablets, laptops, Ultrabook®, portable All-In-Ones and 2-in-1 Detachable/Convertibles, etc.). The calibration apparatus of various embodiments is designed for any user to easily operate and maneuver the system under test while simultaneously calibrating the accelerometer, gyroscope, and magnetometer sensors.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct electrical, optical, or wireless connection between the things that are connected, without any intermediary devices. The term “coupled” means either a direct electrical, optical, or wireless connection between the things that are connected or an indirect connection through one or more passive or active intermediary devices. The term “circuit” means one or more passive and/or active components that are arranged to cooperate with one another to provide a desired function. The term “signal” means at least one current signal, voltage signal or data/clock signal. The meaning of “a,” “an,” and “the” include plural references. The meaning of “in” includes “in” and “on.”

The term “scaling” generally refers to converting a design (schematic and layout) from one process technology to another process technology and subsequently being reduced in area (e.g., layout area). The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level. The terms “substantially,” “close,” “approximately,” “near,” and “about,” generally refer to being within +/−20% of a target value.

Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

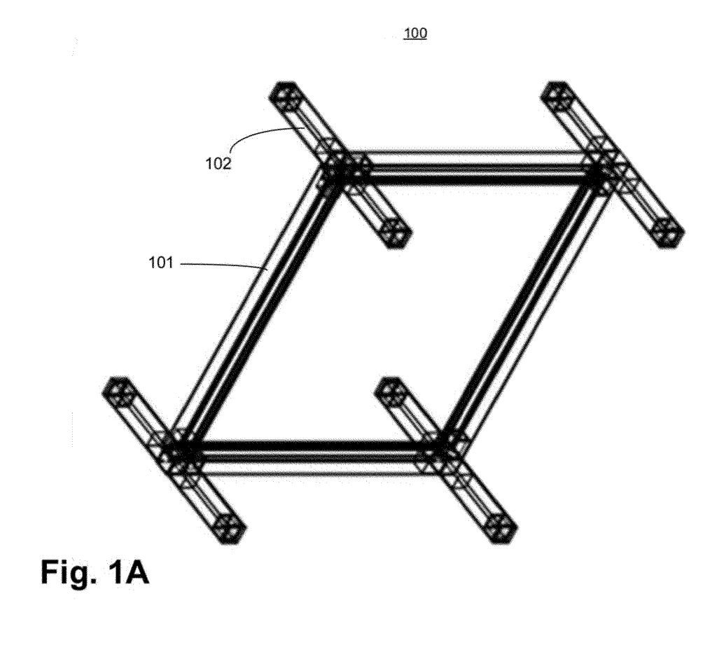

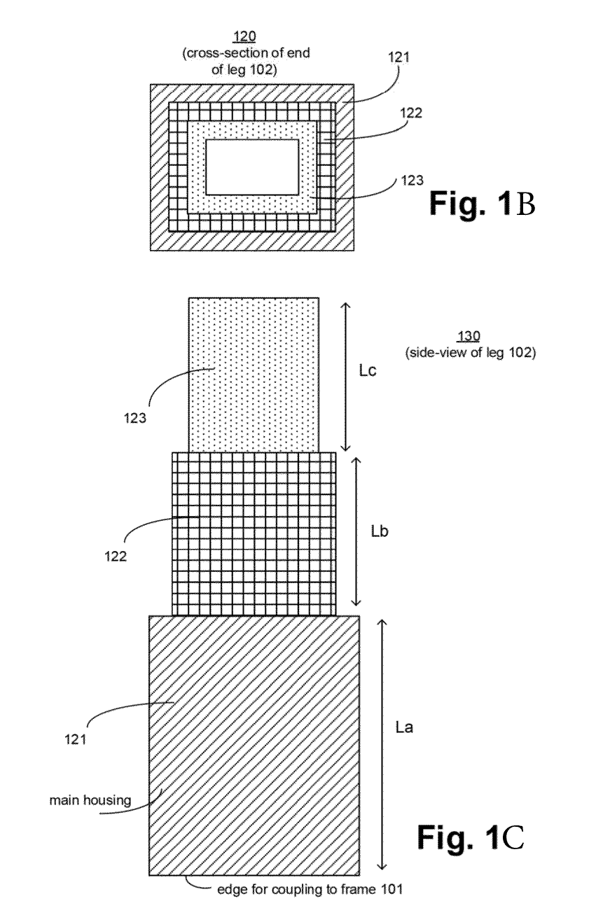

FIG. 1A illustrates a three dimensional (3D) view 100 of a calibration fixture (also referred to as a calibration frame), according to some embodiments of the disclosure. In some embodiments, 3D view 100 of the calibration fixture comprises frame 101 and standing structures 102 (e.g., legs) to place the frame 101 in various positions. In some embodiments, legs 102 are coupled to frame 101 at the corners of frame 101. In some embodiments, legs 102 may couple to frame 101 at the edges of frame 101 and away from the corners of frame 101. While various embodiments described here use four or eight legs (depending on how they are counted), fewer or additional legs 102 may be used with frame 101. In some embodiments, frame 101 and legs 102 are made from the same material. In some embodiments, frame 101 and legs 102 are made from different materials. For example, frame 101 and legs 102 can be made from non-conductive and/or non-magnetic material to avoid any magnetic or electric interference with a DUT (not shown here).

In some embodiments, frame 101 and legs 102 are formed from lightweight aluminum or polypropylene (hard plastic). In some embodiments, the screws and/or joints for coupling the legs 102 to frame 101 are made from aluminum and/or plastic. In some embodiments, the ends of legs 102 are formed from plastic end caps. In other embodiments, other non-magnetic and/or non-conductive material may be used for the ends of legs 102. In some embodiments, legs 102 are perpendicular to frame 101. In other embodiments, legs 102 may be angled (inwards or outwards) relative to frame 101 such that legs 102 can provide various orientations for the DUT.

In some embodiments, frame 101 comprises four body frames that include twin flanges to secure a first sheet (e.g., a 0.25 inches clear plastic base). In some embodiments, legs 102 are of equal lengths. In some embodiments, frame 101 is attached to legs 102 such that length of legs 102 extending on either sides of frame 101 (coupling the legs) are equal in size. In some embodiments, legs 102 are attached to frame 101 such that length of legs extending on either sides of the frame coupling the legs are of different lengths. In this example, view 100 of the calibration fixture shows eight legs and four body frames joined together with plastic joints.

FIG. 1B illustrates a cross-section 120 of an end of a leg of the calibration fixture, according to some embodiments of the disclosure. FIG. 1C illustrates a side-view 130 of the leg of FIG. 1B, according to some embodiments of the disclosure. It is pointed out that those elements of FIG. 1B-C having the same reference numbers (or names) as the elements of any other figure can operate or function in any manner similar to that described, but are not limited to such.

In some embodiments, legs 102 have adjustable lengths. For example, legs 102 can extend out or shrink in to increase or decrease the length of the legs. In some embodiments, each of the legs 102 comprises one or more legs that are housed within the same casing (i.e., main housing) of the leg such that the one or more legs can slide out of the main housing in a staggered fashion to provide varying length sizes. One such embodiment is illustrated with reference to FIGS. 1B-C. In cross-section 120, the main housing 121 is the default leg that has two sub-legs 122 and 123 housed within the main housing. Legs 122 and 123 can slide out of main housing 121 to provide varying lengths to leg 102. For example, the one or more legs that are housed in the main housing can slide out by predetermined distances to change the length of legs 102 by predetermined distances. FIG. 1C shows the side-view with legs 122 and 123 out of the main housing 121. Here, main housing 121 provides length La, leg 122 provides additional length Lb, and leg 123 further provides additional length Lc. Legs 122 and 123 can slide in and out of main housing to change the overall length of leg 102. In some embodiments, additional legs can be coupled to the ends of legs 102 to increase the length of legs 102.

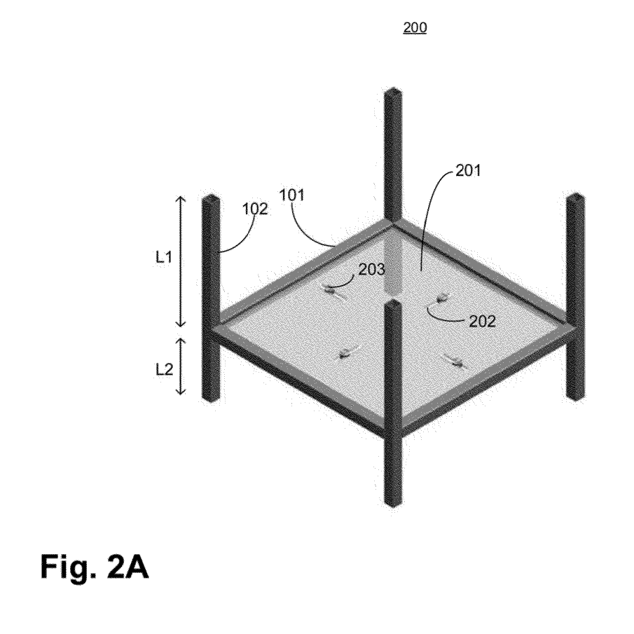

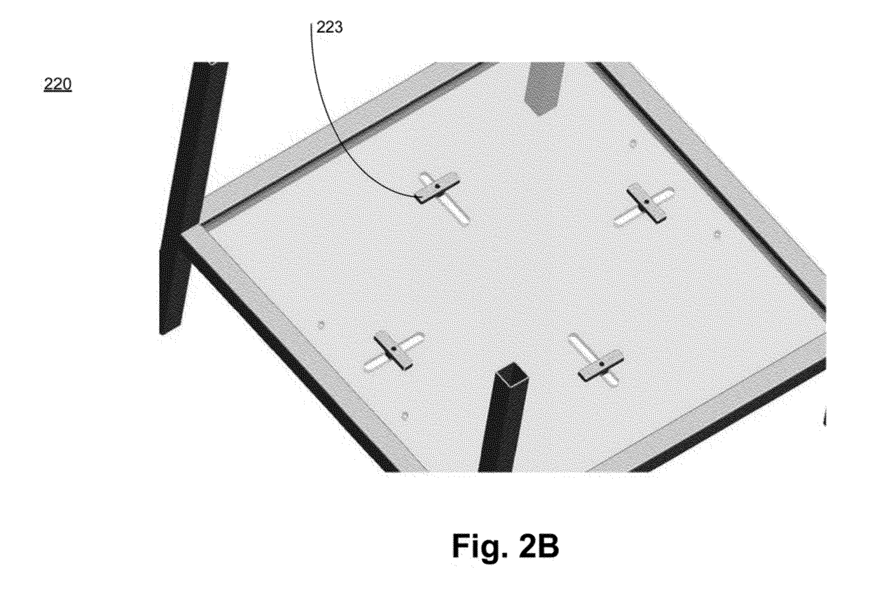

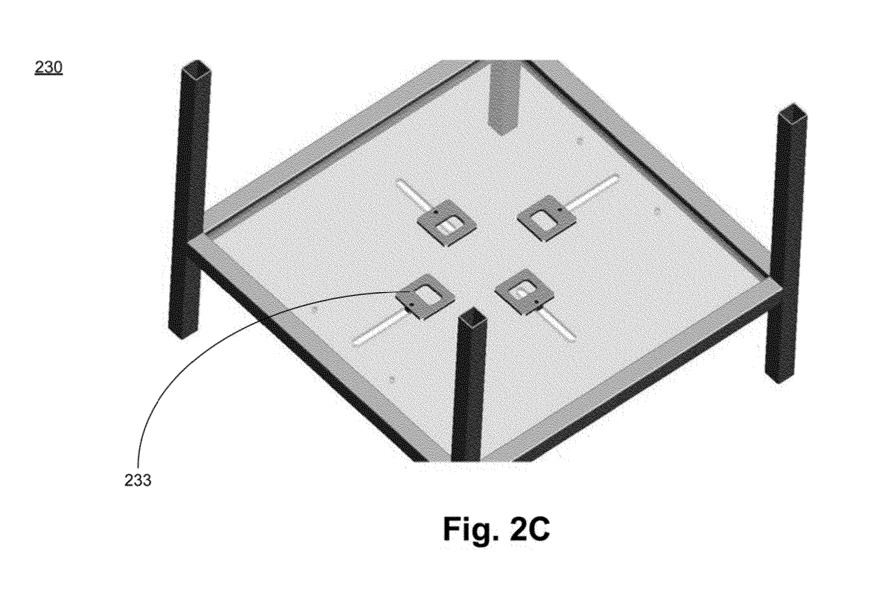

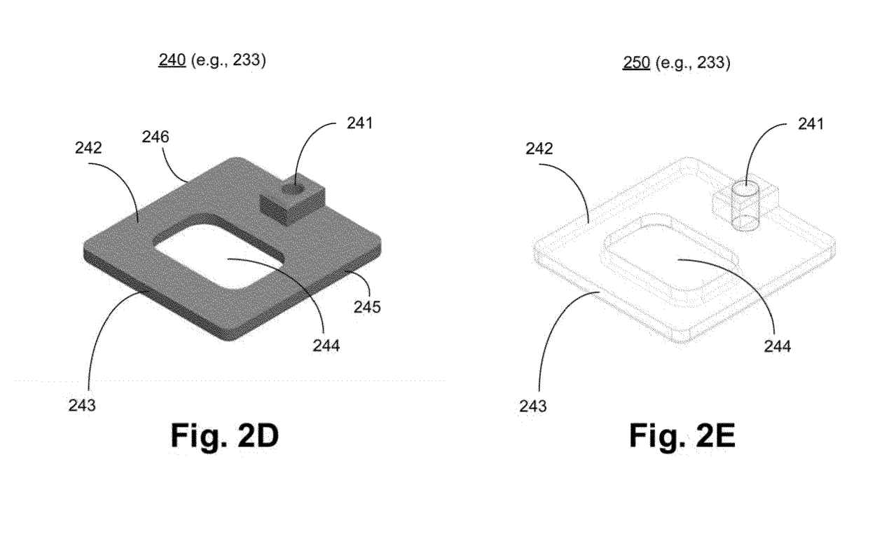

FIG. 2A illustrates a 3D view 200 of the calibration fixture with a first sheet for positioning a DUT (also referred to here as a System-Under-Test (SUT)), according to some embodiments of the disclosure. It is pointed out that those elements of FIG. 2A having the same reference numbers (or names) as the elements of any other figure can operate or function in any manner similar to that described, but are not limited to such.

In some embodiments, legs 102 are attached to frame 101 such that length of legs 102 extending on either sides of frame 101 coupling the legs are of different lengths. For example, legs 102 have length L1 extending from one side of the coupling point (i.e., point where frame 101 couples to the leg) and length L2 extending from another side of the coupling point, were L1 is greater than L2. In this example, view 200 of the calibration fixture shows eight legs and four body frames joined together with plastic joints. In some embodiments, the joints are aluminum joints or joints made from other non-magnetic and/or non-conductive material.

In some embodiments, the four body frames 101 include twin flanges to secure first sheet 201 (e.g., 0.25 inches clear plastic base) in place. In some embodiments, DUT (not shown) sits on first sheet 201 and is secured by a second sheet (not shown). In some embodiments, first sheet 201 has a plurality of slots 202 that allow screws (or stoppers) 203 to move along the direction of the slots. In some embodiments, slots 202 are cut using a laser.

In this example, four slots are shown having four screws. One purpose of the screws is to hold the DUT in position. In some embodiments, slots 202 allow for moving the screws to secure a variety of DUT sizes. In some embodiments, the screws are made from plastic. In other embodiments, other non-conductive materials may be used for the screws. In some embodiments, screws 203 are metal screws with an outer coating of plastic. While the embodiment of FIG. 2A discloses circular stoppers 203, other shapes for stoppers may be used as described with reference to FIGS. 2B-C.

FIG. 2B illustrates a 3D view 220 of part of the calibration fixture having adjustable rectangular stoppers 223 for slots 202 in the first sheet, according to some embodiments of the disclosure. FIG. 2C illustrates a 3D view 230 of part of the calibration fixture having adjustable rectangular stoppers 233 for slots 202 in the first sheet, according to some embodiments of the disclosure. It is pointed out that those elements of FIGS. 2B-C having the same reference numbers (or names) as the elements of any other figure can operate or function in any manner similar to that described, but are not limited to such.

In some embodiments, round stoppers 203 may allow the DUT to be fixed at an angle (e.g., 30 degrees) relative to the edges of first sheet 201. In some embodiments, rectangular stoppers 223 and 233 allow the DUT to be fixed in a position without being able to skew at an angle. For example, the straight edges of rectangular stoppers 223 and 223 flush with the straight edges of the DUT to keep the DUT held in its position firmly without allowing it to slide to an angle as the calibration fixture is oriented in different position for calibrating the one or more sensors on the DUT.

In some embodiments, rectangular stoppers 223 can be adjusted by sliding them out along slots 202 towards the edges of frame 101 to hold larger DUTs (e.g., 15 inch display laptops). In some embodiments, rectangular stoppers 223 can be adjusted by sliding them along slots 202 towards the middle/center of first sheet 201 to hold smaller DUTs (e.g., a tablet such as iPAD® by Apple®). In some embodiments, rectangular stoppers 233 can also be adjusted by sliding them in and out along slots 202 towards the edges of frame 101 or towards the center of first sheet 201 to hold larger DUTs (e.g., 15 inch laptops) as well as much smaller DUTs (e.g., cell phones). In other embodiments, other larger sized stoppers may be used to hold even smaller DUTs (e.g., smart watches and wearable devices).

FIGS. 2D-E illustrates 3D views 240 and 250 of the adjustable rectangular stoppers, according to some embodiments of the disclosure. It is pointed out that those elements of FIGS. 2D-E having the same reference numbers (or names) as the elements of any other figure can operate or function in any manner similar to that described, but are not limited to such.

Here, 3D views 240 and 250 are magnified views of adjustable rectangular (or square) stoppers 233. In some embodiments, adjustable rectangular (or square) stopper 233 as shown by 3D view 240 includes via 241, main area 242, void 244, and edges 243, 245, and 246. In some embodiments, via 241 that receives a metal or plastic screw to hold stopper 233 in slot 202. In some embodiments, to provide additional mechanical strength to the stopper to firmly hold a DUT, via 241 is longer than the thickness of the main area 242 of the stopper. In some embodiments, the thickness of the main area 242 is equal to the height of via 241. In some embodiments, edge 243 flushes with an edge of the DUT to firmly keep the DUT at a predetermined position and prevent the DUT from rotating from its position. In some embodiments, void 244 provides an underlying view of slot 202.

While the embodiments describe rectangular stoppers, triangular stoppers may also be used. For example, edge 243 can be the base of the triangular stopper while edges 245 and 246 can be the angled edges of the stopper extending from the corners of edge 243 towards via 241. In this case, edge 243 is flushed with an edge of DUT. In other embodiments, other shapes for stoppers may be used. For example, trapezoidal shaped stoppers may be used.

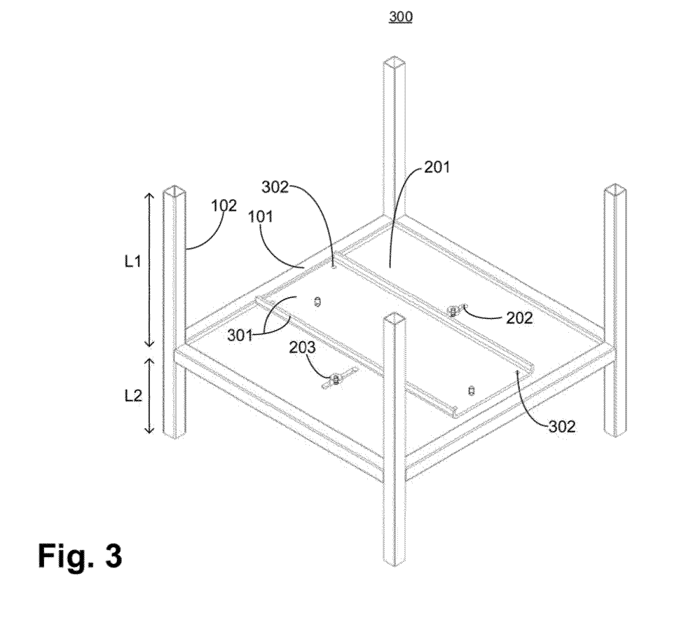

FIG. 3 illustrates 3D view 300 of the calibration frame with a second sheet for holding the DUT in place on the first sheet, according to some embodiments of the disclosure. It is pointed out that those elements of FIG. 3 having the same reference numbers (or names) as the elements of any other figure can operate or function in any manner similar to that described, but are not limited to such.

In some embodiments, second sheet 301 is used to hold the DUT in place between first 201 and second 301 sheets. In some embodiments, second sheet 301 is a thin (e.g., 0.25 inches) clear plastic cover. In some embodiments, second sheet 301 has holes 302. These holes are used by screws (e.g., plastic or plastic coated metal screws) to press the DUT to first sheet 201 such that the DUT is firmly sandwiched between first and second sheets. In some embodiments, the four stoppers 203 (e.g., nylon/plastic or aluminum stoppers) are placed on each side of the DUT to hold the DUT in place. In some embodiments, the DUT sits on laser cut slots 202 on the first sheet 201 (also referred to here as the base), firmly positioned by screws 203, and secured by separate aluminum and plastic thumb screws (not shown here) that pass through holes 302 of the second sheet 301. In some embodiments, slots 202 are designed to secure various DUT sizes. One purpose of stoppers 203 is to keep the DUT in place, centered, and straight when the calibration fixture is in motion.

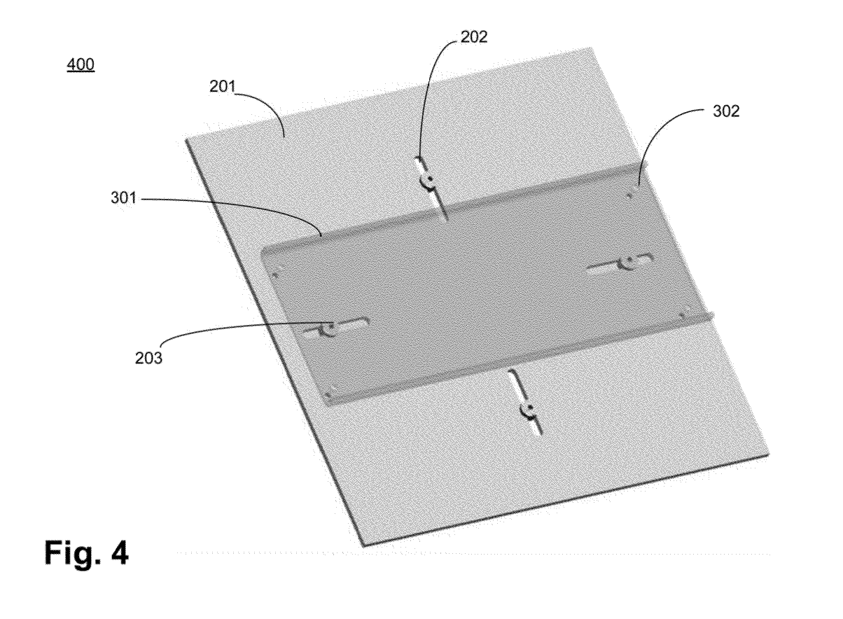

FIG. 4 illustrates another 3D view 400 of the calibration fixture having first 201 and second 301 sheets with adjustable stoppers or fasteners 203, according to some embodiments of the disclosure. It is pointed out that those elements of FIG. 4 having the same reference numbers (or names) as the elements of any other figure can operate or function in any manner similar to that described, but are not limited to such.

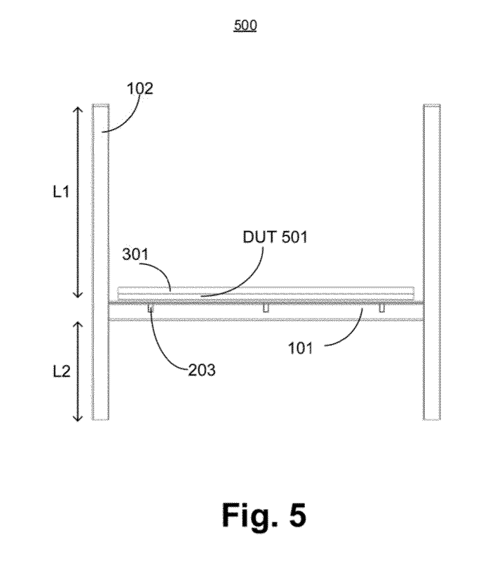

FIG. 5 illustrates side view 500 of the calibration frame with the DUT, according to some embodiments of the disclosure. It is pointed out that those elements of FIG. 5 having the same reference numbers (or names) as the elements of any other figure can operate or function in any manner similar to that described, but are not limited to such. Side view 500 shows DUT 501 securely placed between first and second sheets (201 and 301 respectively).

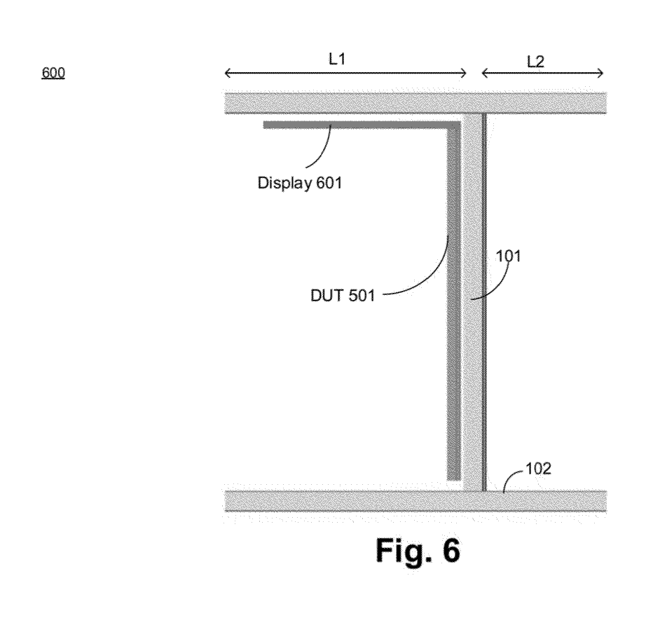

FIG. 6 illustrates another side view 600 of the calibration fixture in a different orientation with a laptop or tablet as DUT 501, according to some embodiments of the disclosure. It is pointed out that those elements of FIG. 6 having the same reference numbers (or names) as the elements of any other figure can operate or function in any manner similar to that described, but are not limited to such. Compared to side view 500, side view 600 of the calibration fixture is oriented such that at least two legs 102 lay flat across their lengths on the floor. In this example, DUT 501 is a laptop or any device and its display 601 rests across length L1 of legs 102 such that the height of display 601 is within length L1 (i.e., height of display 601 is less than length L1). This example illustrates one usage model of having unequal lengths for legs 102 (i.e., L1 is greater than L2). In some embodiments, lengths L1 and L2 are equal such that display 601 is within length L1.

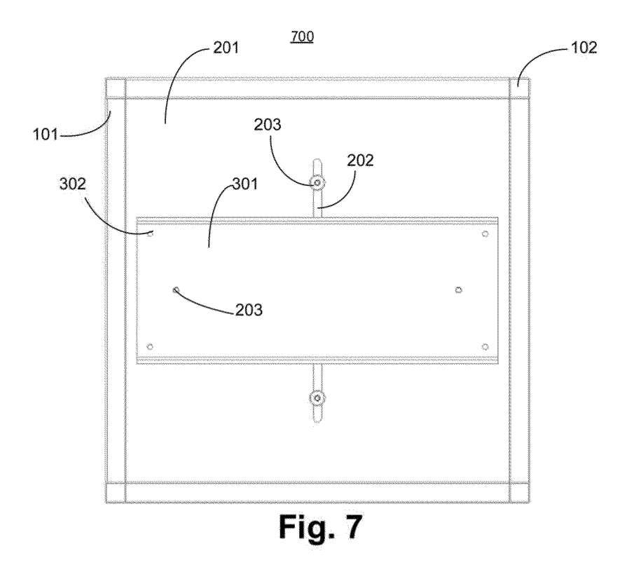

FIG. 7 illustrates top view 700 of the calibration fixture with first and second sheets, according to some embodiments of the disclosure. It is pointed out that those elements of FIG. 7 having the same reference numbers (or names) as the elements of any other figure can operate or function in any manner similar to that described, but are not limited to such. In some embodiments, the surface area of first sheet 201 is smaller than the surface area of second sheet 301. In some embodiments, the surface area of first sheet 201 is equal to the surface area of second sheet 301.

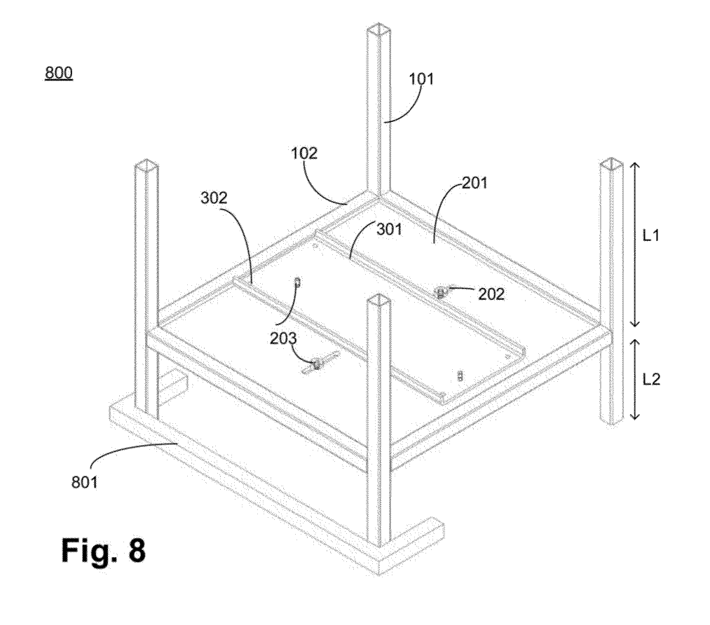

FIG. 8 illustrates 3D view 800 of the calibration fixture anchored to a reference anchor, according to some embodiments of the disclosure. It is pointed out that those elements of FIG. 8 having the same reference numbers (or names) as the elements of any other figure can operate or function in any manner similar to that described, but are not limited to such.

In some embodiments, reference anchor 801 is used to hold legs 102 of the calibration fixture in place so that a calibration position is fixed. In some embodiments, reference anchor 801 is a U-shaped bracket that wraps legs 102 at its corners to hold the calibration unit/fixture. In some embodiments, before calibrating one or more sensors of the DUT, the calibration fixture is flushed against reference anchor 801. In some embodiments, reference anchor 801 is formed of the same material as legs 102. In other embodiments, reference anchor 801 is formed of different material than material(s) used for forming legs 102. In some embodiments, reference anchor 801 is secured/fastened on a flat leveled surface.

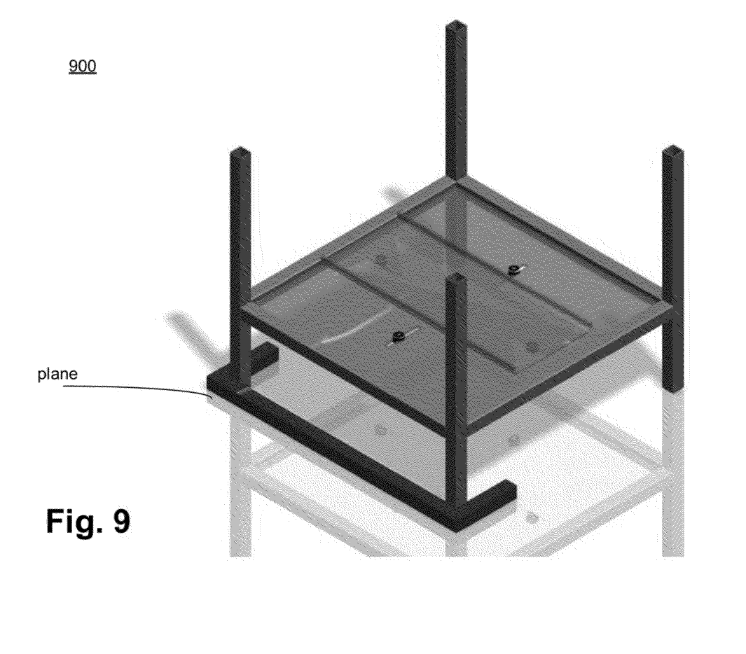

FIG. 9 illustrates another 3D view 900 of the calibration fixture anchored to reference anchor 801, according to some embodiments of the disclosure. It is pointed out that those elements of FIG. 9 having the same reference numbers (or names) as the elements of any other figure can operate or function in any manner similar to that described, but are not limited to such. View 900 illustrates a reflective plane to provide context to the location of reference anchor 801 relative to legs 102 and frame 101 of the calibration fixture.

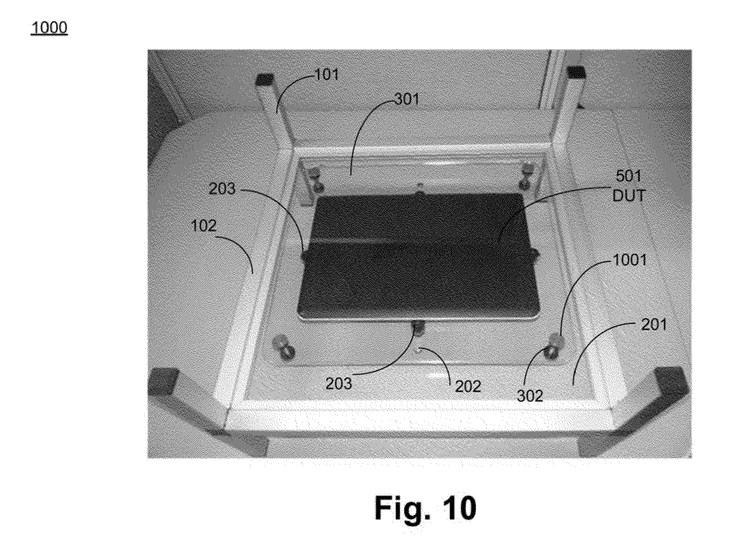

FIG. 10 illustrates 3D picture 1000 of the calibration fixture with DUT 501 firmly positioned between first 201 and second 301 sheets, according to some embodiments of the disclosure. It is pointed out that those elements of FIG. 10 having the same reference numbers (or names) as the elements of any other figure can operate or function in any manner similar to that described, but are not limited to such.

In some embodiments, DUT 501 is first positioned by stoppers 203 by moving the stoppers along slots 202 to firmly hold DUT 501 at its place. The DUT 501 is then sandwiched between first 201 and second sheets 301 and firmly pressed by second sheet 301 by screws 1001 through holes 302. This allows DUT 501 to remain at the same place when the calibration fixture is oriented in different orientations. As screws 1001 are tightened DUT 501 is held from falling down as the calibration fixture is rotated to calibrate one or more sensors of DUT 501 over a series of orientations.

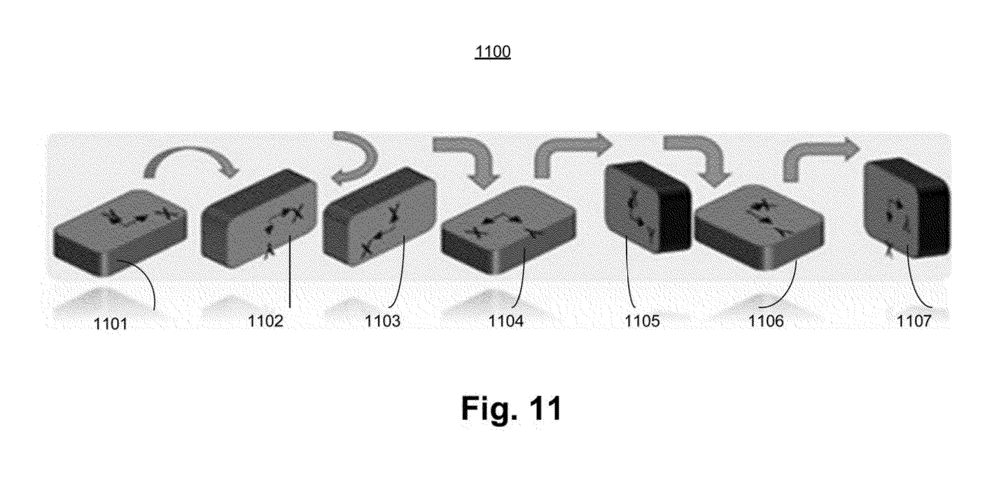

FIG. 11 illustrates a series of orientations 1100 of the calibration frame to calibrate one or more sensors of the DUT, according to some embodiments of the disclosure. It is pointed out that those elements of FIG. 11 having the same reference numbers (or names) as the elements of any other figure can operate or function in any manner similar to that described, but are not limited to such. In some embodiments, one or more sensors of DUT 501 are oriented through a series of orientations 1101, 1102, 1103, 1104, 1105, 1106, and 1107.

Here, seven orthogonal orientations or positions are shown, but fewer or more orientations may be used depending on the type of sensor. The orthogonal orientations are achieved naturally by the calibration fixture which allows a user to position the calibration fixture to known positions, thus reducing errors when calibrating the one or more sensors. In some embodiments, the calibration fixture is rotated by 90 degrees to determine calibration data. For example, orientation 1102 indicates rotation of calibration fixture by 90 degrees relative to orientation 1101. In some embodiments, the calibration fixture is rotated by 180 degrees. In such an example, fewer orientations are used to calibrate the sensors. The X and Y direction of each orientation is shown in FIG. 11. In some embodiments, first sheet 201 is marked with X-Y axis so DUT 501 can be aligned easily to these marks thus helping speed up the process and removing any possibility for DUT 501 to be initially skewed.

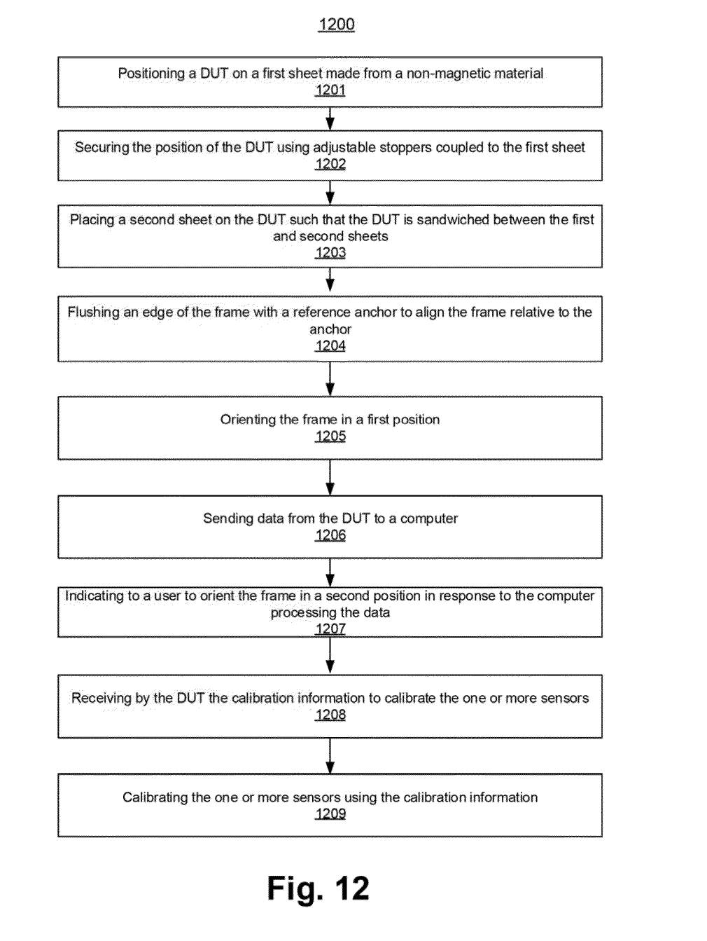

FIG. 12 illustrates flowchart 1200 of a method for calibrating one or more sensors of DUT 501 using the calibration frame, according to some embodiments of the disclosure. It is pointed out that those elements of FIG. 12 having the same reference numbers (or names) as the elements of any other figure can operate or function in any manner similar to that described, but are not limited to such.

Although the blocks in flowchart 1200 with reference to FIG. 12 are shown in a particular order, the order of the actions can be modified. Thus, the illustrated embodiments can be performed in a different order, and some actions/blocks may be performed in parallel. Some of the blocks and/or operations listed in FIG. 12 are optional in accordance with certain embodiments. The numbering of the blocks presented is for the sake of clarity and is not intended to prescribe an order of operations in which the various blocks must occur. Additionally, operations from the various flows may be utilized in a variety of combinations.

At block 1201, DUT 501 having one or more sensors for calibrating are positioned on first sheet 201 made from a non-magnetic material. At block 1202, the position of DUT 501 is secured by screws or stoppers 203 by adjusting the screws or stoppers 203 over slots 202. At block 1203, second sheet 301 is placed on top of DUT 501 and firmly coupled to DUT by screws 1001 through holes 302. As such, DUT 501 is sandwiched between first and second sheets (201 and 301 respectively) so that the DUT does not drop out when the calibration fixture is rotated to various orientations or portions.

At block 1204, an edge of frame 101 of the calibration fixture is flushed to reference anchor 801 to align the calibration fixture relative to reference anchor 801. Now, the calibration system is ready for calibrating the one or more sensors of DUT 501. At block 1205, the calibration fixture is oriented in a first position (e.g., orientation 1101). At block 1206, DUT 501 sends calibration data associated with the one or more sensors to a computer. For example, DUT 501 sends data by wireless means (e.g., Wi-Fi, Bluetooth, etc.) to the computer. In some embodiments, at block 1207, upon successful reception of the calibration data by the computer, a return message is sent back to DUT 501 which provides an indication (e.g., a beep sound, or light flash, etc.) to the user that the calibration fixture is ready for the next orientation (e.g., orientation 1102).

After completing all orientations (e.g., orientations 1101-1107) and receiving data from DUT 501 for all orientations, a software program on the computer or firmware (e.g., hardware) of the computer processes the received data for each orientation and provides calibration information to DUT 501. As such, at block 1208, the calibration information is received by DUT 501 to calibrate the one or more sensors of DUT 501. At block 1209, the one or more sensors are calibrated using the calibration information.

There are many technical effects of various embodiments. For example, various embodiments enhance end-user experience. Enhancement to end-user experience is achieved with consistent and accurate calibration data provided by a magnetic interference free environment from the calibration fixture. Compared to robot arms with metals and motors, various embodiments use non-conductive materials such as aluminum, plastic, and polypropylene sheets thus creating no magnetic interference to the magnetometer sensor of DUT 501. Various embodiments also allow for a single calibration fixture design for various form factors. For example, one calibration fixture is capable of supporting smart phones, tablet, clamshell, 2-in-1s and portable All-In-One devices in different sizes.

Various embodiments also provide an inexpensive design and calibration process that delivers cost savings to computer manufacturers. For example, various embodiments avoid purchase of expensive equipment such as robotic arms or rate tables. Various embodiments also reduce the calibration time at the manufacturing lines. Due to its lightweight design, the calibration fixture of various embodiments can be easily moved and implemented anywhere in an assembly/test line. The calibration fixture of various embodiments allows for faster computer service turnaround time. For example, systems with defective sensor cards can be easily fixed/replaced and calibrated onsite at remote service areas using the modular calibration fixture of various embodiments (i.e., computer service areas do not need to ship defective components for repair and calibration, nor invest in expensive calibration equipment.)

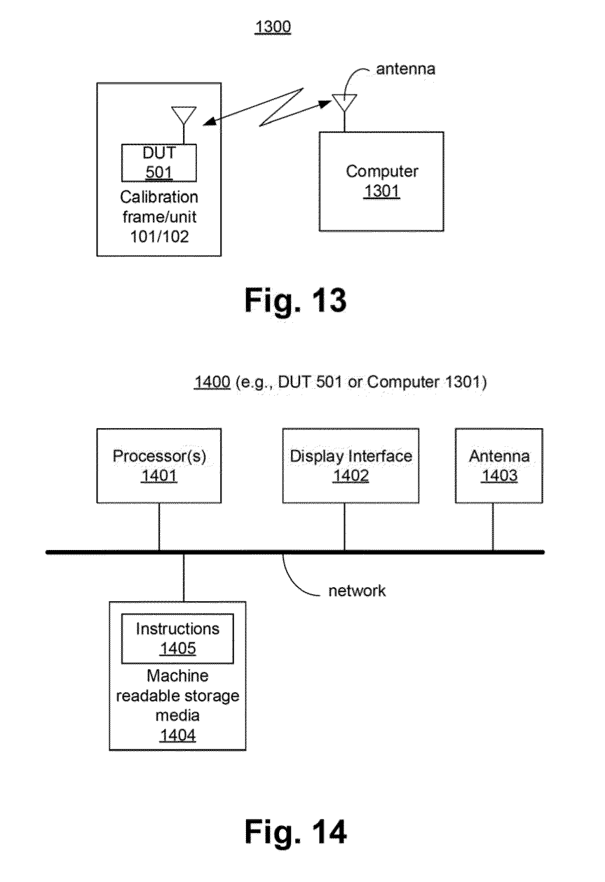

FIG. 13 illustrates system 1300 for processing the calibration data from the calibration unit having the calibration fixture and DUT, according to some embodiments of the disclosure. It is pointed out that those elements of FIG. 13 having the same reference numbers (or names) as the elements of any other figure can operate or function in any manner similar to that described, but are not limited to such.

In some embodiments, system 1300 comprises Computer 1301 which is operable to wirelessly communicate (via an antenna) with DUT 501 of calibration fixture having frame 101 and legs 102. Computer 1301 can be any computer such as a personal desktop computer, laptop, server, cloud computing apparatus, smart phone, tablet, etc. Program software code/instructions associated with flowchart 1200 and executed to implement embodiments of the disclosed subject matter may be implemented as part of an operating system or a specific application, component, program, object, module, routine, or other sequence of instructions or organization of sequences of instructions referred to as “program software code/instructions,” “operating system program software code/instructions,” “application program software code/instructions,” or simply “software” or firmware embedded in processor. In some embodiments, the program software code/instructions associated with flowchart 1200 are executed by Computer 1301.

In some embodiments, the program software code/instructions associated with flowchart 1200 are stored in a computer executable storage medium and executed by Computer 1301. Here, computer executable storage medium is a tangible machine readable medium that can be used to store program software code/instructions and data that, when executed by a computing device, cause a processor to perform a method(s) as may be recited in one or more accompanying claims directed to the disclosed subject matter.

FIG. 14 illustrates a smart device, a computer system, a SoC (System-on-Chip), or DUT 1400, according to some embodiments. It is pointed out that those elements of FIG. 14 having the same reference numbers (or names) as the elements of any other figure can operate or function in any manner similar to that described, but are not limited to such.

In some embodiments, device 1400 comprises one or more processors 1401, Display Interface 1402, Antenna 1403, tangible machine readable storage media 1404, and machine executable instructions 1405 coupled together via a network. The tangible machine readable media 1404 may include storage of the executable software program code/instructions 1405 and data in various tangible locations, including for example ROM (Read Only Memory), volatile RAM (Random Access Memory), non-volatile memory and/or cache and/or other tangible memory as referenced in the present application. Portions of this program software code/instructions 1405 and/or data may be stored in any one of these storage and memory devices. Further, program software code/instructions 1405 can be obtained from other storage, including, e.g., through centralized servers or peer to peer networks and the like, including the Internet. Different portions of software program code/instructions 1405 and data can be obtained at different times and in different communication sessions or in a same communication session.

The software program code/instructions 1405 (associated with flowchart 1200) and data can be obtained in their entirety prior to the execution of a respective software program or application by the computing device. Alternatively, portions of software program code/instructions 1405 and data can be obtained dynamically, e.g., just in time, when needed for execution. Alternatively, some combination of these ways of obtaining software program code/instructions 1405 and data may occur, e.g., for different applications, components, programs, objects, modules, routines or other sequences of instructions or organization of sequences of instructions, by way of example. Thus, it is not required that the data and instructions be on a tangible machine readable medium in entirety at a particular instance of time.

Examples of tangible computer-readable media 1404 include but are not limited to recordable and non-recordable type media such as volatile and non-volatile memory devices, ROM, RAM, flash memory devices, floppy and other removable disks, magnetic disk storage media, optical storage media (e.g., Compact Disk Read-Only Memory (CD ROMS), Digital Versatile Disks (DVDs), etc.), among others. The machine-readable medium 1404 may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions.

For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection). The software program code/instructions 1405 may be temporarily stored in digital tangible communication links while implementing electrical, optical, acoustical or other forms of propagating signals, such as carrier waves, infrared signals, digital signals, etc. through such tangible communication links.

In general, a tangible machine readable media 1404 includes any tangible mechanism that provides (i.e., stores and/or transmits in digital form, e.g., data packets) information in a form accessible by a machine (i.e., a computing device), which may be included, e.g., in a communication device, a computing device, a network device, a personal digital assistant, a manufacturing tool, a mobile communication device, whether or not able to download and run applications and subsidized applications from the communication network, such as the Internet, e.g., an iPhone®, Blackberry® Droid®, or the like, or any other device including a computing device. In one embodiment, processor-based system 1400 is in a form of or included within a PDA, a cellular phone, a notebook computer, a tablet, a game console, a set top box, an embedded system, a TV, a personal desktop computer, etc. Alternatively, the traditional communication applications and subsidized application(s) may be used in some embodiments of the disclosed subject matter.

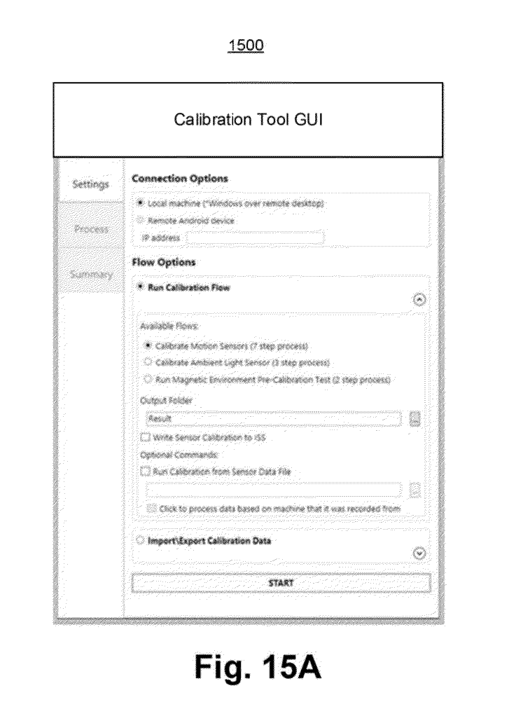

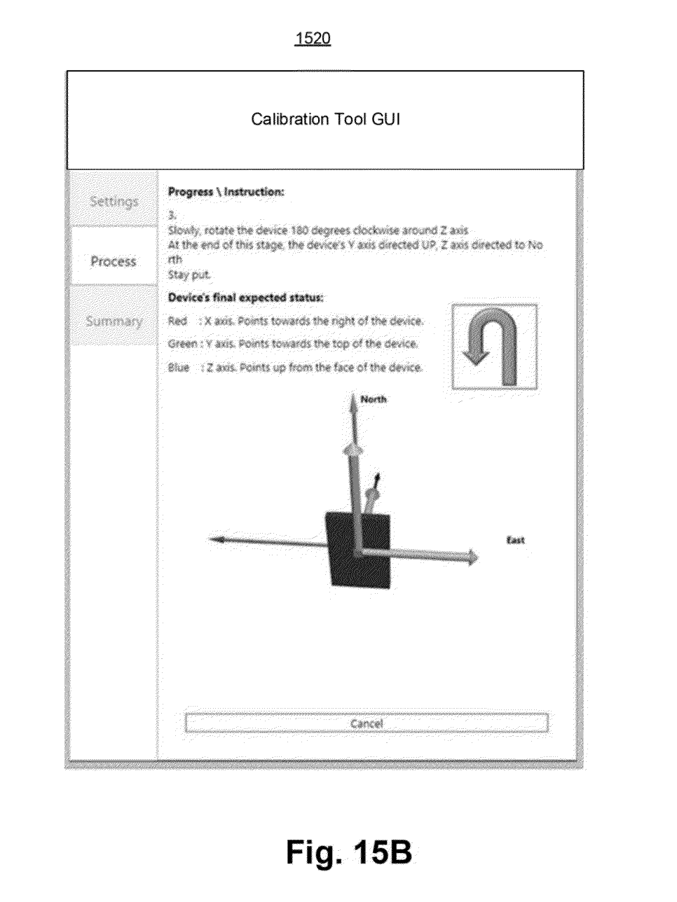

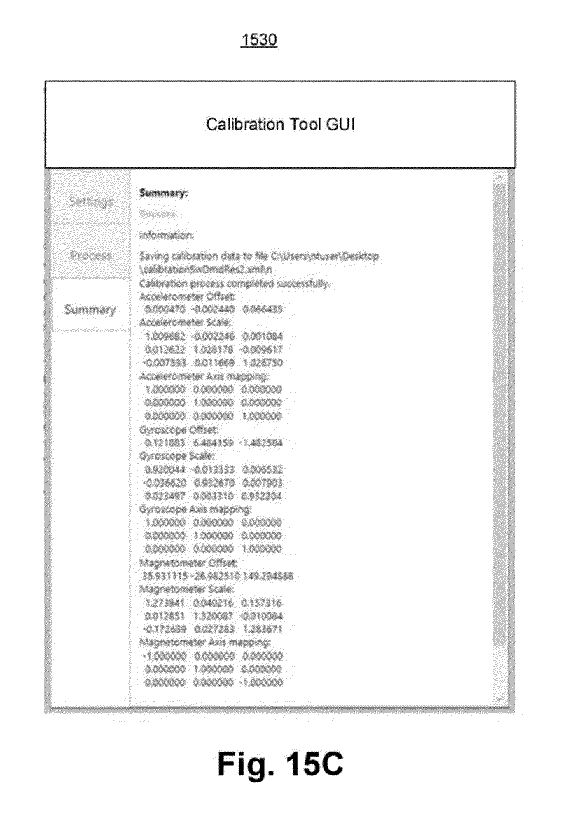

FIG. 15A-C illustrates snapshots 1500, 1520, and 1530 of a calibration tool graphical user interface (GUI) used for processing calibration data from DUT 501, and generating calibration information for one or more sensors of DUT 501, according to some embodiments of the disclosure.

GUI snapshot 1500 illustrates the setting of the calibration tool. In this example, local computer 1301 is used for processing the calibration data. Other options include other wireless devices. In snapshot 1500, the calibration flow options are identified. For example, a seven step process (as described with reference to FIG. 11) is selected to calibrate the one or more motion sensors in DUT 501. Other calibration processes may be selected for other types of sensors. For example, ambient light sensor can be calibrated with a three-step orientation process, a pre-calibration test can be performed by a two-step orientation process, etc. Once the setting is selected, a user can click the START button to begin the calibration process.

GUI snapshot 1520 illustrates the process of calibration using the calibration fixture of various embodiments. In some embodiments, GUI 1520 provides step-by-step instructions to a user for calibrating the one or more sensors. For example, GUI 1520 instructs the user to rotate the calibration fixture to a certain position and for how long. GUI snapshot 1530 illustrates calibration data processed after completing all orientations of the calibration fixture.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. For example, other memory architectures e.g., Dynamic RAM (DRAM) may use the embodiments discussed. The embodiments of the disclosure are intended to embrace all such alternatives, modifications, and variations as to fall within the broad scope of the appended claims.

Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details are set forth in order to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process.

For example, an apparatus is provided which comprises: a first sheet, formed of non-metallic material, to position a DUT; and a frame, formed of non-magnetic material, to support the first sheet such that the frame can be oriented in various positions to calibrate one or more sensors associated with the DUT. In some embodiments, the first sheet includes adjustable stoppers to position the DUT on the first sheet. In some embodiments, the apparatus comprises a second sheet, formed of non-metallic material, coupled to the DUT such that the DUT is sandwiched between the first and second sheets. In some embodiments, the second sheet includes fasteners to maintain position of the second sheet relative to the DUT. In some embodiments, a surface area of the first sheet is larger than a surface area of the second sheet.

In some embodiments, the frame includes at least four legs such that lengths of each of the at least four legs extend on either sides of the first sheet. In some embodiments, surface area of the first sheet extends in a direction perpendicular to the lengths of the at least four legs. In some embodiments, the first sheet is positioned away from centers of the lengths of the at least four legs. In some embodiments, the lengths of the at least four legs are substantially equal to each other. In some embodiments, the lengths of the at least four legs are configurable to be of different lengths. In some embodiments, the frame has at least eight legs. In some embodiments, the one or more sensors of the DUT include at least one of: accelerometer; gyroscope; or magnetometer. In some embodiments, the DUT is at least one of: a laptop, a tablet, a smart device, or a smart phone.

In another example, a method is provided which comprises: positioning a DUT on a first sheet made from a non-metallic material; securing the position of the DUT using adjustable stoppers coupled to the first sheet, wherein the first sheet is coupled to a frame which is made from a non-magnetic material, and wherein the frame supports the first sheet such that the frame can be oriented in various positions to calibrate one or more sensors associated with the DUT; and orienting the frame in various positions one at a time to calibrate the one or more sensors of the DUT.

In some embodiments, the method comprises: placing a second sheet, formed of a non-metallic material, on the DUT such that the DUT is sandwiched between the first and second sheets, wherein the second sheet is placed in response to securing the position of the DUT using adjustable stoppers. In some embodiments, the method comprises: securing the second sheet in a position to hold firmly the DUT on the first sheet. In some embodiments, the method comprises: flushing an edge of the frame with a reference anchor to align the frame relative to the anchor.

In some embodiments, the method comprises: sending data from the DUT to a computer separate from the DUT after orienting the frame, the computer to process the data and to determine calibration information for the one or more sensors; and indicating to a user to orient the frame in a different orientation in response to the computer processing the data. In some embodiments, the method comprises: receiving, by the DUT, the calibration information to calibrate the one or more sensors; and calibrating the one or more sensors using the calibration information. In some embodiments, orienting the frame in various positions comprises orienting the frame in orthogonal positions.

In another example, a system is provided which comprises: a computer for processing data transmitted by a DUT; a calibrating unit comprising: a first sheet, formed of non-metallic material, to position the DUT; and a frame, formed of non-metallic material, to support the first sheet such that the frame can be oriented in various positions to calibrate one or more sensors associated with the DUT; and an anchor for flushing an edge of the frame with the anchor to align the frame relative to the anchor. In some embodiments, the first sheet includes adjustable stoppers to position the DUT on the first sheet. In some embodiments, the system comprises: a second sheet, formed of non-magnetic material, coupled to the DUT such that the DUT is sandwiched between the first and second sheets.

In some embodiments, a surface area of the first sheet is larger than a surface area of the second sheet. In some embodiments, the frame includes at least four legs such that lengths of each of the at least four legs extend on either sides of the first sheet. In some embodiments, surface area of the first sheet extends in a direction perpendicular to the lengths of the at least four legs. In some embodiments, the first sheet is positioned away from centers of the lengths of the at least four legs. In some embodiments, the lengths of the at least four legs are substantially equal to each other.

In some embodiments, the lengths of the at least four legs are configurable to be of different lengths. In some embodiments, the frame has at least eight legs. In some embodiments, the one or more sensors of the DUT include at least one of: accelerometer; gyroscope; or magnetometer. In some embodiments, the DUT is at least one of: a laptop, a tablet, a smart device, or a smart phone.

In another example, an apparatus is provided which comprises means for positioning a DUT on a first sheet made from a non-metallic material; means for securing the position of the DUT using adjustable stoppers coupled to the first sheet, wherein the first sheet is coupled to a frame which is made from a non-magnetic material, and wherein the frame supports the first sheet such that the frame can be oriented in various positions to calibrate one or more sensors associated with the DUT; and means for orienting the frame in various positions one at a time to calibrate the one or more sensors of the DUT.

In some embodiments, the apparatus comprises: means for placing a second sheet, formed of a non-metallic material, on the DUT such that the DUT is sandwiched between the first and second sheets, wherein the second sheet is placed in response to securing the position of the DUT using adjustable stoppers. Un some embodiments, the apparatus comprises: means securing the second sheet in a position to hold firmly the DUT on the first sheet. In some embodiments, the apparatus comprises: means flushing an edge of the frame with a reference anchor to align the frame relative to the anchor.

In some embodiments, the apparatus comprises: means for sending data from the DUT to a computer separate from the DUT after orienting the frame, the computer to process the data and to determine calibration information for the one or more sensors; and means for indicating to a user to orient the frame in a different orientation in response to the computer processing the data. In some embodiments, the apparatus comprises: means for receiving, by the DUT, the calibration information to calibrate the one or more sensors; and means for calibrating the one or more sensors using the calibration information.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

We claim:

1. An apparatus comprising:
a first sheet, formed of non-metallic material, to position a device under test (DUT); and
a frame, formed of non-magnetic material, to support the first sheet such that the frame can be oriented in various positions to calibrate one or more sensors associated with the DUT.

2. The apparatus of claim 1, wherein the first sheet includes adjustable stoppers to position the DUT on the first sheet.

3. The apparatus of claim 1 comprises a second sheet, formed of non-metallic material, coupled to the DUT such that the DUT is sandwiched between the first and second sheets.

4. The apparatus of claim 3, wherein the second sheet includes fasteners to maintain position of the second sheet relative to the DUT.

5. The apparatus of claim 3, wherein a surface area of the first sheet is larger than a surface area of the second sheet.

6. The apparatus of claim 1, wherein the frame includes at least four legs such that lengths of each of the at least four legs extend on either sides of the first sheet.

7. The apparatus of claim 6, wherein surface area of the first sheet extends in a direction perpendicular to the lengths of the at least four legs.

8. The apparatus of claim 6, wherein the first sheet is positioned away from centers of the lengths of the at least four legs.

9. The apparatus of claim 6, wherein the lengths of the at least four legs are substantially equal to each other.

10. The apparatus of claim 6, wherein the lengths of the at least four legs are configurable to be of different lengths.

11. The apparatus of claim 1, wherein the frame has at least eight legs.

12. The apparatus of claim 1, wherein the one or more sensors of the DUT include at least one of:
accelerometer;
gyroscope; or
magnetometer.

13. The apparatus of claim 1, wherein the DUT is at least one of: a laptop, a tablet, a smart device, or a smart phone.

14. A method comprising:
positioning a device under test (DUT) on a first sheet made from a non-metallic material;
securing the position of the DUT using adjustable stoppers coupled to the first sheet, wherein the first sheet is coupled to a frame which is made from a non-magnetic material, and wherein the frame supports the first sheet such that the frame can be oriented in various positions to calibrate one or more sensors associated with the DUT; and
orienting the frame in various positions one at a time to calibrate the one or more sensors of the DUT.

15. The method of claim 14 comprises:
placing a second sheet, formed of a non-metallic material, on the DUT such that the DUT is sandwiched between the first and second sheets, wherein the second sheet is placed in response to securing the position of the DUT using adjustable stoppers.

16. The method of claim 15 comprises:
securing the second sheet in a position to hold firmly the DUT on the first sheet.

17. The method of claim 15 comprises:
flushing an edge of the frame with a reference anchor to align the frame relative to the anchor.

18. The method of claim 14, wherein orienting the frame in various positions comprises orienting the frame in orthogonal positions.

19. A system comprising:
a computer for processing data transmitted by a device under test (DUT);
a calibrating unit comprising:
a first sheet, formed of non-metallic material, to position the DUT; and
a frame, formed of non-metallic material, to support the first sheet such that the frame can be oriented in various positions to calibrate one or more sensors associated with the DUT; and
an anchor for flushing an edge of the frame with the anchor to align the frame relative to the anchor.

20. The system of claim 29, wherein the first sheet includes adjustable stoppers to position the DUT on the first sheet.

21. The system of claim 19 comprises a second sheet, formed of non-magnetic material, coupled to the DUT such that the DUT is sandwiched between the first and second sheets.
